(19) United States
(12) Patent Application Publication
(10) Pub. No.: US 2007/0245384 A1
(43) Pub. Date: Oct. 18, 2007

(54) External notification methods and apparatus for cellular communications

(76) Inventors: Edward Walter, Boerne, TX (US); Michael Delaney JR., San Antonio, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/402,705

(22) Filed: Apr. 12, 2006

(51) Int. Cl. H04Q 7/22; H04N 7/16

(52) U.S. Cl. 725/62

(57) ABSTRACT

External notification methods and apparatus for cellular communications are disclosed. An example external notification apparatus disclosed herein comprises a first interface to receive an incoming call notification in a first format from a cellular device, a second interface to route the incoming call notification in a second format to a multimedia device and receive configuration information from the multimedia device, and a configuration unit to process the configuration information received from the multimedia device.

### FIELD OF THE DISCLOSURE

This disclosure relates generally to cellular communication systems and, more particularly, to external notification methods and apparatus for cellular communications.

### BACKGROUND

Cellular devices are ubiquitous in today's society because they provide voice, data and video communication capabilities and entertainment for consumers at almost any time and in almost any place. For example, cellular devices range from the common mobile cellular telephone to personal digital assistants and personal computers having integrated cellular communication capability. In fact, cellular communication has become so prevalent that many consumers employ a mobile cellular telephone as their primary communication device in the home. However, while the consumer typically keeps his or her cellular device nearby when traveling outside the home, the consumer may not be conscious of the location of his or her cellular phone while in the home. For example, a consumer may leave his or her cellular device on a table or in a purse and then move to another room of the house to watch television, use a personal computer, etc. As such, incoming calls received by the cellular device may be missed by the consumer while the consumer engages in other tasks, such as watching television, using a personal computer, etc.

### BRIEF DESCRIPTION OF THE DRAWINGS

FIG. 1 is a block diagram of an example incoming call notification system.

FIG. 2 is a block diagram illustrating an example pairing operation to pair an example cellular device and an example external notification device in the example incoming call notification system of FIG. 1.

FIG. 3 is a block diagram of a first example external notification device that may be used to implement the example incoming call notification system of FIG. 1.

FIG. 4 is a block diagram of a second example external notification device that may be used to implement the example incoming call notification system of FIG. 1.

FIG. 5 is a flowchart representative of example machine readable instructions that may be executed to implement an example connection configuration procedure that may be used, at least in part, to implement the example incoming call notification system of FIG. 1 and/or the example external notification devices of FIGS. 1, 3 and/or 4.

FIG. 6 is a flowchart representative of example machine readable instructions that may be executed to implement an example notification routing procedure that may be used, at least in part, to implement the example incoming call notification system of FIG. 1 and/or the example external notification devices of FIGS. 1, 3 and/or 4.

FIG. 7 is a flowchart representative of example machine readable instructions that may be executed to implement an example notification format conversion procedure that may be used to implement the machine readable instructions of FIG. 6.

FIG. 8 is a block diagram of an example computer that may execute at least portions of the example machine readable instructions of FIGS. 5, 6 and/or 7 to implement the example external notification devices of FIGS. 1, 3 and/or 4, and/or an example multimedia device for use in the example incoming call notification system of FIG. 1.

### DETAILED DESCRIPTION

An example external notification device disclosed herein may include a first interface to: (1) establish a wireless connection with a cellular device and/or (2) receive an incoming call notification in a first format from the cellular device. The example external notification device may also include a second interface to: (1) route the incoming call notification in a second format to a multimedia device and/or (2) receive configuration information from the multimedia device. The example external notification device may further include a notification generator to convert the incoming call notification from the first format to the second format and a configuration unit to process the configuration information received from the multimedia device. Additionally or alternatively, the example external notification device may include a pairing evaluator to determine whether the cellular device is paired with the external notification device.

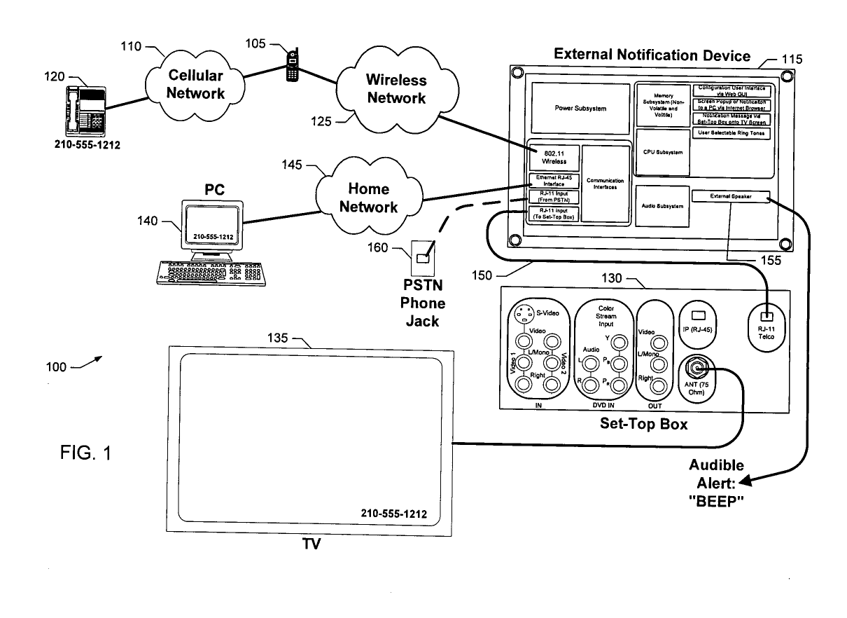

FIG. 1 is block diagram of an example incoming call notification system 100 that may employ any or all of the example methods and/or apparatus disclosed herein. The example incoming call notification system 100 includes a cellular device 105 capable of sending and receiving voice and/or data calls over a cellular network 110. The cellular device 105 may correspond to any type of cellular device, such as, but not limited to, a mobile cellular telephone, a personal digital assistant (PDA), a cellular communication adapter for use with a personal computer, etc. The cellular device 105 and the cellular network 110 may be configured to support any type of cellular communication standard or group of standards, such as, but not limited to, one or more of a time division multiple access (TDMA) cellular standard, a code division multiple access (CDMA) cellular standard, a global system for mobile communications (GSM) cellular standard, a universal mobile telecommunications system (UMTS) cellular standard, etc.

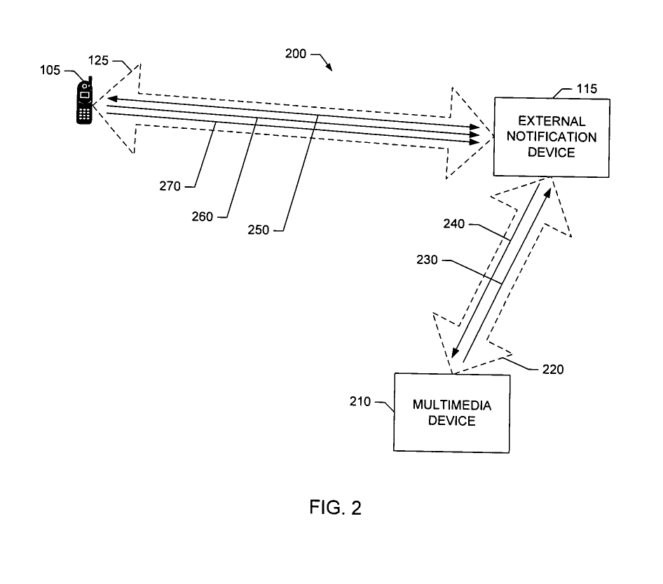

The example incoming call notification system 100 also includes an external notification device 115 configured to receive incoming call notifications from the cellular device 105. An incoming call notification may correspond to a voice and/or data call received by the cellular device 105. For example, as shown in FIG. 1, the cellular device 105 may receive an incoming voice call over the cellular network 110 from a public switched telephone network (PTSN) telephone 120. Upon receipt of an incoming voice and/or data call, the cellular device 105 may be configured to transmit the corresponding incoming call notification over a local wireless network 125 to the external notification device 115. For example, the cellular device 105 may be a multi-band device and support any type of local wireless communication standard in addition to the one or more supported cellular communication standards. The supported local wireless standards corresponding to the local wireless network 125 may include, but are not limited to, a wireless local area network (WLAN), such as, for example, the IEEE 802.11 WLAN standard, the Bluetooth wireless standard, etc. Furthermore, and as discussed in greater detail below in connection with FIG. 2, the cellular device 105 and the external notification device 115 may be paired over the wireless network 125 to achieve secure communications and/or limit the cellular devices able to communicate with the external notification device 115.

The incoming call notification transmitted by the cellular device 105 to the external notification device 115 may be formatted, for example, as an alert message conforming to the protocol implementing the wireless network 125. Additionally or alternatively, the incoming call notification may be formatted to include, for example, caller identification (ID) information to be processed by the external notification device 115. The caller ID information may include the originating caller's phone number, the originating caller's name, the originating caller's text/email address, etc. Furthermore, the incoming call notification may be encrypted to, for example, prevent eavesdropping and ensure secure communications.

The example incoming call notification system 100 further includes one or more multimedia devices 130, 135 and/or 140. The one or more multimedia devices may include, but are not limited to, a set-top box (STB) 130, a television (TV) 135, a personal computer (PC) 140, etc. For example, and as shown in FIG. 1, the example incoming call notification system 100 may include the STB 130 coupled to the TV 135, and the PC 140 coupled to a home network 145. The STB 130 may correspond to any type of STB, such as, but not limited to, an analog cable television STB, a digital cable television STB, a satellite television STB, a video cassette recorder (VCR), etc. The TV 135 may correspond to any type of TV, such as, but not limited to, a TV supporting a standard analog television standard, a high-definition television standard (HDTV), etc. The PC 140 may correspond to any type of PC, such as, but not limited to, a desktop PC, a laptop PC, a notebook PC, a PDA, etc. The home network 145 may correspond to any type of home network, such as, but not limited to, a local area network (LAN), for example, conforming to an Ethernet standard, a WLAN, for example, conforming to the IEEE 802.11 WLAN standard, etc.

The external notification device 115 may be configured to route the incoming call notification received from the cellular device 105 to one or more of the multimedia devices 130, 135 and/or 140. For example, and referring to FIG. 1, the external notification device 115 may route the incoming call notification over a digital interface 150 to the STB 130 for presentation by the TV 135. The digital interface 150 may correspond to any type of digital interface, such as but not limited to, a serial interface, for example, implemented as a serial bus over a registered jack (RJ) 11 interface, a universal serial bus (USB) interface, etc., or a parallel interface, etc.

In the preceding example, the external notification device 115 may reformat the incoming call notification received from the cellular device 105 into a format suitable for transmission to the STB 130 over the digital interface 150. For example, the incoming call notification transmitted to the STB 130 may be formatted to cause a pop-up window to be displayed by the TV 135 indicating that an incoming call is being received by the cellular device 105. As such, the incoming call notification may be formatted to include pop-up window parameters, such as, for example, window location, window size, window color, display duration, default text message to display, etc. Furthermore, the incoming call notification transmitted to the STB 130 may be formatted to include any caller ID information received from the cellular device 105 and corresponding to the incoming call. The caller ID information may then be displayed by the TV 135 in the pop-up window. Additionally or alternatively, the incoming call notification transmitted to the STB 130 may be formatted to include distinctive ring tone information to cause the TV 135 to emit an audible signal personalized to the cellular device 105 associated with the incoming call and/or the caller ID information associated with the incoming call.

In another example, the external notification device 115 may route the incoming call notification over the home network 145 to the PC 140. In this example, the external notification device 115 may reformat the incoming call notification received from the cellular device 105 into a format suitable for transmission to the PC 140 over the home network 145. For example, the incoming call notification transmitted to the PC 140 may be formatted to cause a browser pop-up window to be displayed by the PC 140 indicating that an incoming call is being received by the cellular device 105. As such, the incoming call notification may be formatted to include browser pop-up window parameters, such as, for example, window location, window size, window color, display duration, text message to display, etc. Furthermore, the incoming call notification transmitted to the PC 140 may be formatted to include any caller ID information received from the cellular device 105 and corresponding to the incoming call. The caller ID information may then be displayed by the PC 140 in the browser pop-up window. Additionally or alternatively, the incoming call notification transmitted to the PC 140 may be formatted to include distinctive ring tone information to cause the PC 140 to emit an audible signal personalized to the cellular device 105 associated with the incoming call and/or the caller ID information associated with the incoming call.

The external notification device 115 may optionally support an external speaker 155 and/or an interface to PTSN phone jack 160. The external speaker 155 may be used by the external notification device 115 to emit an audible signal (e.g., such as a distinctive ring tone) corresponding to receipt of the incoming call notification from the cellular device 105. The external notification device 115 may be configured to emit the audible signal in addition to, or as an alternative to, routing the incoming call notification to one or more of the multimedia devices 130, 135 and/or 140. The interface to the PSTN phone jack 160 may be used by the external notification device 115 to route incoming call notifications from a PSTN phone (not shown) coupled to the PSTN phone jack 160 for presentation by one or more of the multimedia devices 130, 135 and/or 140.

In an example operation of the incoming call notification system 100, an originating caller initiates a voice call to the cellular device 105 from the PSTN phone 120 having an example phone number of 210-555-1212. The voice call is routed through the cellular network 110 and received by the cellular device 105. The cellular device 105, which is paired with the external notification device 115 (as discussed below in connection with FIG. 2), sends an incoming call notification over the local wireless network 125 to the external notification device 115. The incoming call notification includes caller ID information associated with the originating caller, including the originating phone number 210-555-1212.

Next, the external notification device 115 reformats the incoming call notification to include pop-up window information and routes the reformatted incoming call notification over the digital interface 150 to the STB 130. The STB 130 then uses the received pop-up window information to cause the TV 135 to present a pop-up window containing the originating phone number 210-555-1212 to notify a user in the vicinity of the TV 135 that an incoming call is being received by the cellular device 105. The STB 130 may also cause the TV 135 to emit an audible signal (e.g., a distinctive ring tone) to notify the user that the incoming call is being received by the cellular device 105. Additionally or alternatively, the external notification device 115 may reformat the incoming call notification for routing over the home network 145 to the PC 140. The PC 140 may the use browser pop-up window information included in the reformatted incoming call notification to present a browser pop-up window containing the originating phone number 210-555-1212 on the display of the PC 140. The reformatted incoming call notification may also cause the PC 140 to emit an audible signal (e.g., a distinctive ring tone) to notify the user that the incoming call is being received by the cellular device 105.

FIG. 2 is a block diagram illustrating an example pairing operation 200 to pair the cellular device 105 and the external notification device 115 in the example incoming call notification system 100 to achieve secure communications and/or restrict which cellular devices are allowed to communicate with the external notification device 115. Pairing of the cellular device 105 and the external notification device 115 may be performed during configuration of the example incoming call notification system 100 and involves establishing a trusted relationship between the cellular device 105 and the external notification device 115. Such configuration may be triggered, for example, during initial setup of the example incoming call notification system 100, when an unpaired cellular device 105 attempts to communicate with the external notification device 115, at predetermined time intervals, etc.

Any known technique for establishing a trusted relationship between devices may be used in the example incoming call notification system 100. For example, the trusted relationship may involve sharing one or more secret passkeys between the cellular device 105 and the external notification device 115. In the case of public key cryptography, the cellular device 105 has an associated key pair that includes a private key known only to the cellular device 105 and a public key to be exchanged with the external notification device 115. To authenticate the cellular device 105 and, thus, achieve pairing between the cellular device 105 and the external notification device 115, the cellular device 105 may encrypt its public key with its private key and transmit the encrypted public key to the external notification device 115. The external notification device 115 then decrypts the received encrypted public key using a stored version of the public key of the cellular device 105. If the decrypted public key and stored public key match, the external notification device 115 authenticates the cellular device 105 and treats the cellular device 105 as being paired with the external notification device 115 during subsequent communications of incoming call notifications. For further security, the cellular device 105 and external notification device 115 may encrypt communications between the two devices using any known encryption technique, such as, for example, symmetric cryptography, asymmetric (public key) cryptography, etc.

Turning to the example pairing operation 200 of FIG. 2, configuration of the pairing between the cellular device 105 and the external notification device 115 may be performed by entering configuration commands into the external notification device 115 through a multimedia device 210 (e.g., such as any or all of the STB 130, the TV 135 and/or the PC 140). The multimedia device 210 is coupled to the external notification device 115 via an interface 220 (e.g., such as the home network 145 and/or the digital interface 150). To begin configuration, the external notification device 115 may initiate a communication 230 over the interface 220 to cause the multimedia device 210 to display a configuration menu. The configuration menu prompts a user to enter configuration commands via an input device of the multimedia device 210 (e.g., a keyboard, a remote control, etc.). The input configuration commands are then sent to the external notification device 115 through a communication 240. For example, one of the configuration commands may configure the external notification device 115 to operate in a “roaming mode,” which allows the external notification device 115 to receive incoming call notifications from any cellular device 105 (e.g., paired or unpaired) and, thus, corresponds to an unsecured mode of operation. Conversely, another configuration command may configure the external notification device 115 to operate in a “secure mode,” which restricts the external notification device 115 to receiving incoming call notifications from only paired cellular devices 105 and, thus, corresponds to a secure mode of operation.

If the external notification device 115 is configured to operate in the secure mode, the external notification device 115 may then initiate a communication exchange 250 that allows the cellular device 105 and external notification device 115 to exchange secret passkeys (e.g., such as exchanging public keys for use with a public key cryptographic algorithm). The external notification device 115 then uses the exchanged passkey information to authenticate the cellular device 105 during subsequent communications. For example, prior to sending an incoming call notification to the external notification device 115, the cellular device 105 may first establish that it is paired with the external notification device 115 by transmitting a communication 260 containing authentication information (e.g., such as an encrypted version of its public key). The external notification device 115 then authenticates the cellular device 105 based on the authentication information included in the communication 260 (e.g., such as by decrypting the encrypted public key of the cellular device 105 and comparing it with a stored version of the public key). If the cellular device 105 is authenticated, the external notification device 115 determines that it is paired with the cellular device 105 and accepts subsequent incoming call notifications 270 from the cellular device 105.

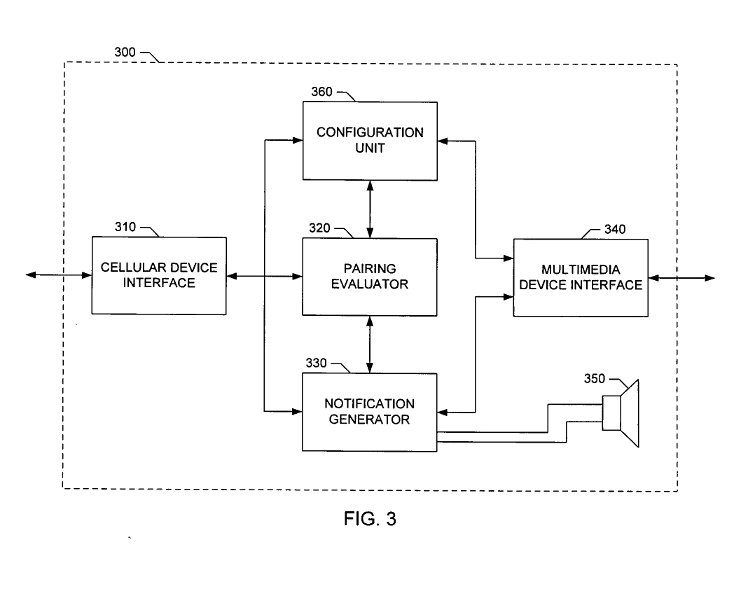

A block diagram of a first example external notification device 300 that may be used to implement the external notification device 115 for use in the example incoming call notification system 100 of FIG. 1 is illustrated in FIG. 3. The example external notification device 300 includes a cellular device interface 310 to communicate with, for example, the cellular device 105 of FIG. 1. The cellular device interface 310 may implement, for example, an interface to the local wireless network 125. As such, the cellular device interface 310 may be configured to receive wireless communications from the cellular device 105 corresponding to any type of local wireless network, such as, for example, an IEEE 802.11 WLAN, a Bluetooth WLAN, etc. The wireless communications from the cellular device 105 may include configuration messages to establish pairing and/or a wireless connection between the cellular device 105 and the example external notification device 300, as well as incoming call notifications transmitted from the cellular device 105 to the example external notification device 300. The incoming call notifications may be formatted, for example, as an alert message and/or a message that includes caller identification (ID) information associated with the incoming call.

The example external notification device 300 also includes a pairing evaluator 320 to determine whether the cellular device 105 is paired with the example external notification device 300. The pairing evaluator 320 may evaluate authentication information provided by the cellular device 105 in a communication received via the cellular device interface 310. The authentication information may be based on secret passkey information exchanged between the cellular device 105 and the example external notification device 300. For example, if public key cryptography is used to implement pairing of devices, then the cellular device 105 will provide the example external notification device 300 with its public key during a configuration procedure. The authentication information provided by the cellular device 105 may then include an encrypted version of its public key, with the public key encrypted with the private key associated with cellular device 105. To authenticate the cellular device 105, the pairing evaluator 320 decrypts the encrypted public key received from the cellular device 105 and compares the decrypted public key with a stored version of the public key previously received from the cellular device 105. If the decrypted and stored public keys match, the pairing evaluator 320 authenticates the cellular device 105, thus indicating that the cellular device 105 is paired with the example external notification device 300. Upon determining that the cellular device 105 is paired with the example external notification device 300, the pairing evaluator 320 enables further receipt of incoming call notifications from the cellular device 105.

To process received incoming call notifications from the cellular device 105, the example external notification device 300 includes a notification generator 330. Operation of the notification generator 330 may be conditioned, for example, upon a pairing determination made by the pairing evaluator 320 if the example external notification device 300 is configured to operate in a secure mode. The notification generator 330 is configured to reformat the incoming call notification received from the cellular device 105 into a format suitable for transmission to a multimedia device (e.g., such as any or all of the STB 130, the TV 135 and/or the PC 140). For example, the incoming call notification may be reformatted to cause a pop-up window to be displayed by the multimedia device indicating that an incoming call is being received by the cellular device 105. As such, the incoming call notification may be formatted to include pop-up window parameters, such as, for example, window location, window size, window color, display duration, default text message to display, etc. Furthermore, the incoming call notification may be reformatted to include any caller ID information received from the cellular device 105 such that caller ID information may then be displayed by the multimedia device in the pop-up window. Additionally or alternatively, the incoming call notification may be reformatted to include distinctive ring tone information to cause the multimedia device to emit an audible signal personalized to the cellular device 105 associated with the incoming call and/or the caller ID information associated with the incoming call.

To route the reformatted incoming call notification to the appropriate multimedia device, the example external notification device 300 includes a multimedia device interface 340. The multimedia device interface 340 may implement, for example, any appropriate interface to the multimedia device. As such, the multimedia device interface 340 may be configured to transmit communications (e.g., such as reformatted incoming call notifications, configuration menu information, etc.) to the multimedia device over the home network 145 and/or the digital interface 150. Furthermore, the multimedia device interface 340 may be configured to receive communications (e.g., such as configuration commands, etc.) from the multimedia device over the home network 145 and/or the digital interface 150.

Optionally, the example external notification device 300 may include an external speaker 350 configured to emit an audible signal (e.g., such as a distinctive ring tone) corresponding to receipt of the incoming call notification from the cellular device 105. The external speaker 350 may be configured to emit the audible signal in addition to, or as an alternative to, routing the reformatted incoming call notification over the multimedia device interface 340 for presentation by the multimedia device.

The example external notification device 300 also includes a configuration unit 360 to support configuration of the communication link between the cellular device 105 and the example external notification device 300, configuration of the presentation of visible and/or audible incoming call notification information by the multimedia device, etc. The configuration unit 360 may be configured to initiate a configuration procedure when the example external notification device 300 is powered on, when an input (not shown) of the example external notification device 300 is asserted, when a new cellular device 105 is detected by the cellular device interface 310, etc. To begin configuration, the configuration unit 360 may initiate a communication via the multimedia device interface 340 to cause a receiving multimedia device to display a configuration menu. The configuration menu may prompt a user to enter configuration commands via an input device of the multimedia device (e.g., a keyboard, a remote control, etc.). The configuration commands input by the user are then sent back to the example external notification device 300 via the multimedia device interface 340 for processing by the configuration unit 360.

For example, one of the configuration commands may configure the example external notification device 300 to operate in a “roaming mode,” which allows the example external notification device 300 to receive incoming call notifications from any cellular device 105 (e.g., paired or unpaired) and, thus, corresponds to an unsecured mode of operation. Another example configuration command may configure the example external notification device 300 to operate in a “secure mode,” which restricts the example external notification device 300 to receiving incoming call notifications from only paired cellular devices 105 and, thus, corresponds to a secure mode of operation. This same example configuration command or still another example configuration command may also cause the example external notification device 300 to request the cellular device 105 to exchange secret passkey information to enable authentication, pairing, secure communications, etc. Still another example configuration command or commands may allow a user to configure parameters for presenting incoming call notification information via the multimedia device. For example, the parameters may include a pop-up window location, a pop-up window size, a pop-up window color, a pop-up window display duration, a default text message to display, whether caller ID information should be displayed in the pop-up window, whether a distinctive ring tone should be emitted by the multimedia device, etc.

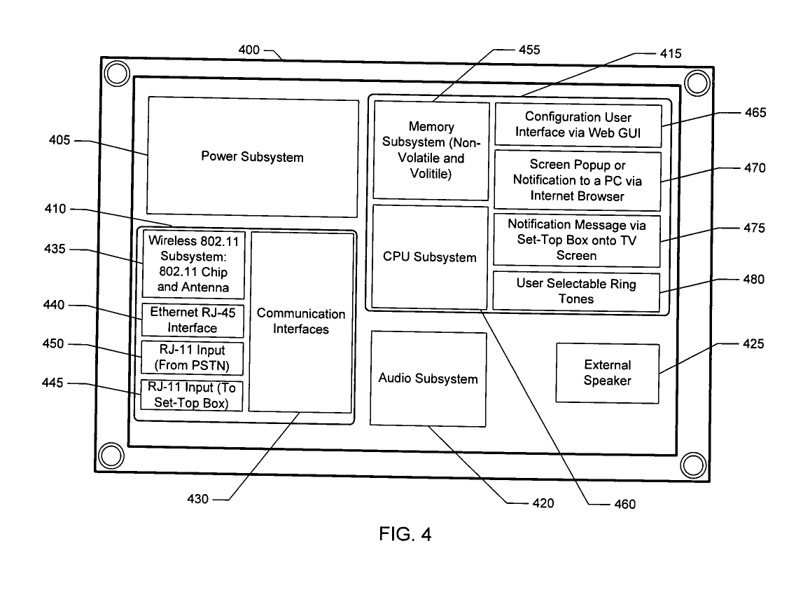

A block diagram of a second example external notification device 400 that may be used to implement the external notification device 115 for use in the example incoming call notification system 100 of FIG. 1 is illustrated in FIG. 4. The example external notification device 400 includes a power subsystem 405, a communications subsystem 410, a processing subsystem 415, an audio subsystem 420 and an external speaker 425. The power subsystem 405 performs power regulation and management for the other subsystems included in the example external notification device 400. Techniques for power regulation and management are known and, thus, are not discussed further herein.

The communications subsystem 410 includes various communication interfaces 430 to support communication between the example external notification device 400 and one or more cellular devices 105, one or more multimedia devices (e.g., such as any or all of the STB 130, the TV 135 and/or the PC 140), etc. The communication interfaces 430 include an integrated IEEE 802.11 wireless chipset and antenna interface 435, an Ethernet RJ-45 interface 440, an RJ-11 interface 445 for interfacing with a STB and an RJ-11 interface 450 for interfacing with a PSTN jack. The IEEE 802.11 interface 435 provides an interface (e.g., such as the cellular device interface 310 of FIG. 3) between the example external notification device 400 and one or more cellular devices 105. The IEEE 802.11 family of standards currently includes six over-the-air modulation techniques that all use the same protocol. The most popular (and prolific) techniques are those defined by the IEEE 802.11 (b), (a), and (g) amendments to the original standard. Security was included in the original IEEE 802.11 specification, and was later enhanced via the 802.11(i) amendment. Other standards in the family ((c)-(f), (h)-(j), (n)) provide service enhancements and extensions, or include corrections to previous specifications. IEEE 802.11(b) was the first widely accepted wireless networking standard, followed by IEEE 802.11(a) and IEEE 802.11(g). The IEEE 802.11(b) and IEEE 802.11(g) standards utilize the 2.40 gigahertz (GHz) band, operating under Part 15 of the FCC Rules and Regulations. The 802.11(a) standard utilizes the 5 GHz band.

The example external notification device 400 may employ the IEEE 802.11 interface 435 to implement a micronet that includes a limited number of cellular devices 105 (and/or other communication devices). For example, the example external notification device 400 could operate as the micronet master while all other communication devices (e.g., the cellular devices 105) could operate as slaves on the micronet. In this configuration, communication devices (e.g., the cellular devices 105) would communicate directly with the example external notification device 400 and would not exchange information directly with each other. Furthermore, the communication devices (e.g., the cellular devices 105) could be paired with the example external notification device 400 using the techniques described above and unpaired communication devices could be prohibited from communicating with the example external notification device 400.

The Ethernet RJ-45 interface 440 provides an interface (e.g., such as the multimedia device interface 340 of FIG. 3) to multimedia devices (e.g., such as the PC 140) coupled to the example external notification device 400 via a home network (e.g., such as the home network 145 of FIG. 1). Ethernet is a frame-based computer networking technology for LANs. RJ-45 is a physical interface used for terminating twisted pair type cables and includes eight pins (i.e., electrical connections) per connector. Thus, the RJ-45 Ethernet interface 440 provides a physical (RJ-45 ) and layer 2 (Ethernet) connection from the example external notification device 400 to a LAN (e.g., the home network 145) and ultimately to a multimedia device (e.g., the PC 140) coupled to the LAN. As such, the RJ-45 Ethernet interface 440 allows incoming call notification messages to be sent from the example external notification device 400 to any multimedia device coupled to this interface. Furthermore, the RJ-45 Ethernet interface 440 allows, for example, configuration commands to be received by the example external notification device 400 from any multimedia device coupled to this interface.

The RJ-11 interface 445 provides an interface (e.g., such as the multimedia device interface 340 of FIG. 3) to multimedia devices (e.g., such as the STB 130) coupled to the example external notification device 400 via a digital interface (e.g., such as the digital interface 150 of FIG. 1). The RJ-11 interface 445 supports serial digital communications between the example external notification device 400 and the multimedia device (e.g., the STB 130) coupled to this interface. As such, the RJ-11 interface 445 allows, for example, incoming call notification messages to be sent from the example external notification device 400 to any multimedia device coupled to this interface. Furthermore, the RJ-11 interface 445 allows, for example, configuration commands to be received by the example external notification device 400 from any multimedia device coupled to this interface. The second RJ-11 interface 450 may be used to route incoming call notifications from a PSTN phone (not shown) coupled to the RJ-11 interface 450 for presentation by one or more multimedia devices coupled to the example external notification device 400.

The example external notification device 400 may include additional communication interfaces 430 such as, for example, a Bluetooth interface to provide an additional or alternative interface (e.g., such as the cellular device interface 310 of FIG. 3) to one or more cellular devices 105. Bluetooth provides a standard for wireless personal area networks (PANs). A Bluetooth PAN may be configured as a piconet that includes up to eight active devices in a master-slave relationship (furthermore, up to 255 devices can be connected in parked mode). A piconet typically has a range of 10 meters, although ranges of up to 100 meters can be achieved under ideal circumstances. In an example Bluetooth PAN, the example external notification device 400 could operate as the piconet master while all other communication devices (e.g., the cellular devices 105) could operate as slaves on the piconet.

The processing subsystem 415 includes a memory subsystem 455 and a central processing unit (CPU) 460 to provide storage and processing capability, respectively, to support, for example, any or all of the functionality associated with the pairing evaluator 320, the notification generator 330 and/or the configuration unit 360 of FIG. 3 described above. For example, the memory subsystem 455 and the central processing unit (CPU) 460 may provide: (1) graphical user interface (GUI) configuration screen functionality 465 for displaying a GUI configuration screen on a multimedia device, (2) pop-up window notification functionality 470 for presenting incoming call notification information in a browser pop-up window on a PC 140, (3) pop-up window notification functionality 475 for presenting incoming call notification information in a pop-up window on a STB 130 or TV 135, and/or (4) distinctive ring tone functionality 480 for presenting incoming call information as an audible signal emitted from a multimedia device coupled to the example external notification device 400.

The example external notification device 400 includes the audio subsystem 420 and the external speaker 425 (e.g., such as the external speaker 350 of FIG. 3) to generate audible signals corresponding to receipt of an incoming call notification from a cellular device 105. The audio subsystem 420 and the external speaker 425 may be configured to emit the audible signal in addition to, or as an alternative to, routing the incoming call notification for presentation by the multimedia device. Audio subsystems and external speakers are known and, thus, are not discussed further herein.

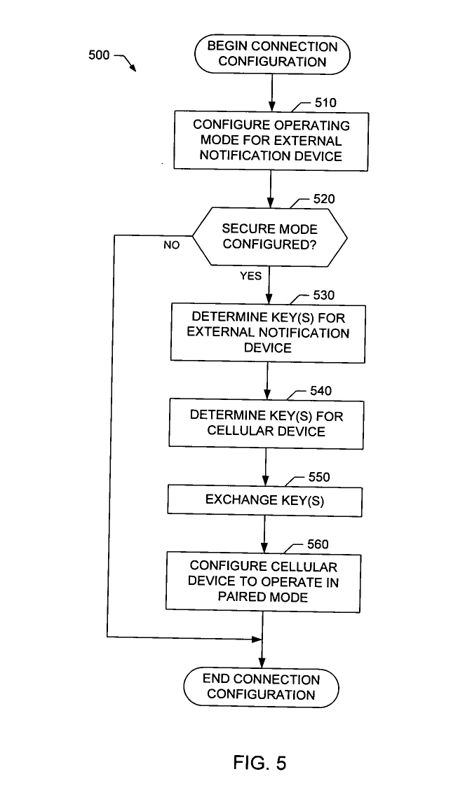

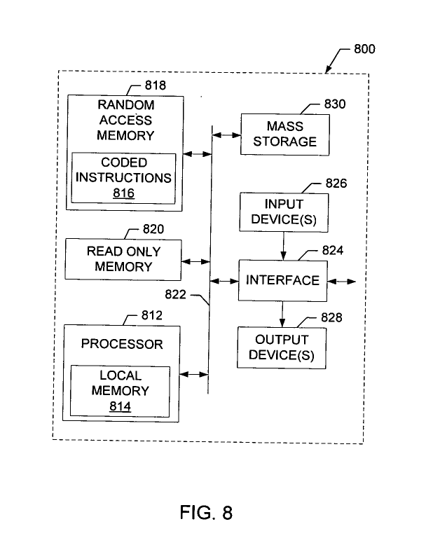

Flowcharts representative of example machine readable instructions that may be executed, at least in part, to implement the example incoming call notification system 100 of FIG. 1, the external notification device 115 of FIG. 1, the external notification device 300 of FIG. 3 and/or the external notification device 400 of FIG. 4 are shown in FIGS. 5-7. In these examples, the machine readable instructions represented by each flowchart may comprise one or more programs for execution by: (a) a processor, such as the processor 812 shown in the example computer 800 discussed below in connection with FIG. 8, (b) a controller, and/or (c) any other suitable device. The one or more programs may be embodied in software stored on a tangible medium such as, for example, a flash memory, a CD-ROM, a floppy disk, a hard drive, a DVD, and/or a memory associated with the processor 812. However, persons of ordinary skill in the art will readily appreciate that the entire program or programs and/or portions thereof could alternatively be executed by a device other than the processor 812 and/or embodied in firmware or dedicated hardware in a well-known manner (e.g., implemented by an application specific integrated circuit (ASIC), a programmable logic device (PLD), a field programmable logic device (FPLD), discrete logic, etc.). For example, any or all of the example incoming call notification system 100, the external notification device 115, the external notification device 300 and/or the external notification device 400 could be implemented by any combination of software, hardware, and/or firmware. Also, some or all of the machine readable instructions represented by the flowchart of FIGS. 5-7 may be implemented manually. Further, although the example machine readable instructions are described with reference to the flowcharts illustrated in FIGS. 5-7, persons of ordinary skill in the art will readily appreciate that many other techniques for implementing the example methods and apparatus described herein may alternatively be used. For example, with reference to the flowcharts illustrated in FIGS. 5-7, the order of execution of the blocks may be changed, and/or some of the blocks described may be changed, eliminated, combined and/or subdivided into multiple blocks.

Example machine readable instructions 500 that may be executed, at least in part, to implement the incoming call notification system 100 of FIG. 1 and/or any or all of the external notification devices 115, 300 and/or 400 of FIGS. 1, 3 and 4, respectively, are shown in FIG. 5. Referring also to FIG. 1, the example machine readable instructions 500 enable configuration of the connection between the cellular device 105 and the external notification device 115 and may be executed at predetermined intervals, when the external notification device 115 is powered on, when an input (not shown) of the external notification device 115 is asserted, when a new cellular device 105 is detected by the external notification device 115, etc. The machine readable instructions 500 begin execution at block 510 at which the external notification device 115 configures its operating mode. For example, the external notification device 115 may operate in a roaming mode, which allows the external notification device 115 to receive incoming call notifications from any cellular device 105 whether or not it is paired with the external notification device 115. Conversely, the external notification device 115 may be configured to operate in a secure mode, which restricts the external notification device 115 to receiving incoming call notifications from only paired cellular devices 105.

The machine readable instructions at block 510 enable entering of configuration commands into the external notification device 115 through a multimedia device (e.g., such as any or all of the STB 130, the TV 135 and/or the PC 140). To begin configuration at block 510, the external notification device 115 transmits information to the multimedia device causing the multimedia device to display a configuration GUI. The configuration GUI prompts a user of the multimedia device to enter configuration commands via an associated input device of the multimedia device (e.g., a keyboard, a remote control, etc.). The input configuration commands are then sent back to the external notification device 115. The configuration commands include a selection of whether the external notification device 115 is to operate in a roaming mode or a secure mode.

Next, control proceeds to block 520 at which the external notification device determines whether it is configured to operate in a roaming mode or a secure mode. If the external notification device 115 is configured to operate in a roaming mode (block 520), execution of the example machine readable instructions 500 ends. However, if the external notification device 115 is configured to operate in a secure mode, control proceeds to block 530. At block 530, the external notification device 115 determines secret passkey information to associate with the external notification device 115 and enable secure communications through pairing of the external notification device 115 with one or more cellular devices 105. For example, if public key cryptography is utilized for pairing and/or secure communications, at block 530 the external notification device 115 may generate a key pair to associate with the external notification device 115 that contains a public key to be shared with the one or more cellular devices 105 and a private key to be known only by the external notification device 115. The external notification device 115 may generate this key pair, for example, based on configuration information received from the multimedia device at block 510. Additionally or alternatively, the external notification device 115 may be pre-configured with stored passkey information such as, for example, a pre-stored public and private key pair.

Next, control proceeds to block 540 at which the passkey information for one or more of the cellular devices 105 is determined. For example, at block 540 the external notification device 115 may generate a key pair to associate with a particular cellular device 105 that contains a public key to be shared with the external notification device 115 and a private key to be known only by the cellular device 105. The external notification device may generate this key pair based on, for example, configuration information received from the multimedia device at block 510. Additionally or alternatively, the cellular device 105 may generate this passkey information at block 540 based on information input into the cellular device 105 (e.g., such as information downloaded to the cellular device 105 via a key pad interface of the cellular device 105, a digital interface of the cellular device 105, the cellular network 110, the wireless network 125, etc.) Additionally or alternatively, the cellular device 105 may be pre-configured with stored passkey information such as, for example, a pre-stored public and private key pair.

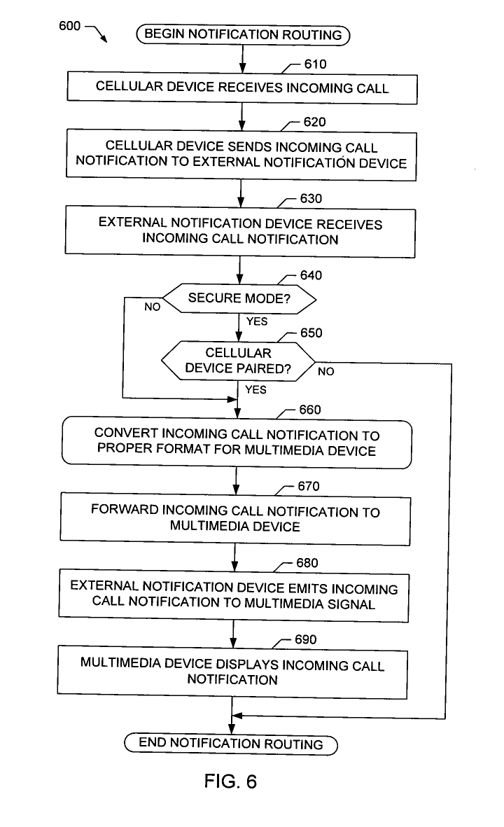

Next, control proceeds to block 550 at which the external notification device 115 initiates a communication exchange over the wireless network 125 that allows the cellular device 105 and the external notification device 115 to exchange secret passkey information (e.g., such as exchanging public keys for use with a public key cryptographic algorithm). The external notification device 115 will use the exchanged passkey information to authenticate the cellular device 105 during subsequent communications (e.g., as discussed in greater detail below in connection with FIG. 6). Control then proceeds to block 560 at which the cellular device 105 is configured to operate in paired mode based on the secret passkey information exchanged at block 560. For example, the cellular device 105 may be configured to operate in the paired mode based on configuration information entered via a key pad interface of the cellular device 105, a digital interface of the cellular device 105, the cellular network 110, the wireless network 125, etc. Execution of the example machine readable instructions 500 then ends.

Example machine readable instructions 600 that may be executed, at least in part, to implement the incoming call notification system 100 of FIG. 1 and/or any or all of the external notification devices 115, 300 and/or 400 of FIGS. 1, 3 and 4, respectively, are shown in FIG. 6. Referring also to FIG. 1, the example machine readable instructions 600 enable routing of incoming call notifications from the cellular device 105 to one or more multimedia devices (e.g., such as any or all of the STB 130, the TV 140 and/or the PC 140). The example machine readable instructions 600 may be executed each time the cellular device 105 receives an incoming call. Typically, the machine readable instructions 600 will be executed after configuration of the connection between the cellular device 105 and the external notification device 115 by, for example, the machine readable instructions 500 of FIG. 5.

The example machine readable instructions 600 begin execution at block 610 at which the cellular device 105 receives an incoming call. The incoming call may be, for example, a voice and/or data call received over the cellular network 110. Next, control proceeds to block 620 at which the cellular device 105 sends an incoming call notification corresponding to the incoming call received at block 610 to the external notification device 115. At block 620, the incoming call notification may be sent to the external notification device 115 over the wireless network 125 in a format, for example, corresponding to an alert message conforming to the protocol implementing the wireless network 125. Additionally or alternatively, the incoming call notification may be formatted to include, for example, caller identification (ID) information to be processed by the external notification device 115. The caller ID information may include the originating caller's phone number, the originating caller's name, the originating caller's text/email address, etc. Furthermore, the incoming call notification may be encrypted to, for example, prevent eavesdropping and ensure secure communications. Encryption may be achieved using secure passkey information previously exchanged between the cellular device 105 and the external notification device 115 by, for example, the machine readable instructions 500.

Next, control proceeds to block 630 at which the external notification device 115 receives the incoming call notification over the wireless interface 125 from the cellular device 105. Control then proceeds to block 640 at which the external notification device 115 determines whether it has been configured to operate in a secure mode (e.g., by the machine readable instructions 500). If the external notification device 115 is configured to operate in a secure mode (block 640), control proceeds to block 650 at which the external notification device 115 determines whether it has been paired with the cellular device 105 corresponding to the incoming call notification received at block 630.

For example, at block 650 the external notification device 115 may evaluate authentication information transmitted by the cellular device 105 to the external notification device 115 prior to and/or with the incoming call notification received at block 630. In the case of public key cryptography, the authentication information transmitted by the cellular device 105 may include its encrypted public key, wherein the cellular device 105 encrypts its public key using its secret private key. Then, at block 650 the external notification device 115 authenticates the cellular device 105 by decrypting the encrypted public key using a stored version of the public key associated with the cellular device 105 (e.g., which was stored in the external notification device 115 by the example machine readable instructions 500). If the decrypted public key does not match the stored public key, the external notification device 115 determines at block 650 that the cellular device 105 is not authenticated and is, thus, not paired with the external notification device 115. Because the cellular device 105 is not paired, further communications between the cellular device 105 and the external notification device 115 are prohibited and, thus, execution of the example machine readable instructions 600 ends.

However, if the decrypted public key matches the stored public key, the external notification device 115 at block 650 determines that the cellular device 105 is authenticated and, thus, is paired with the external notification device 115. If the cellular device 105 is paired with the external notification device 115 (block 650), or if the external notification device is not operating in secure mode and is, thus, operating in roaming mode (block 640), control proceeds to block 660. At block 660, the external notification device 115 reformats the incoming call notification received from the cellular device 105 at block 630 into a format suitable for transmission to a multimedia device coupled to the external notification device 115. For example, if the multimedia device corresponds to the STB 130, at block 660 the external notification device 115 may reformat the incoming call notification to be compatible with transmission over the digital interface 150. Additionally or alternatively, if the multimedia device corresponds to the PC 140, at block 660 the external notification device 115 may reformat the incoming call notification to be compatible with transmission over the home network 145.

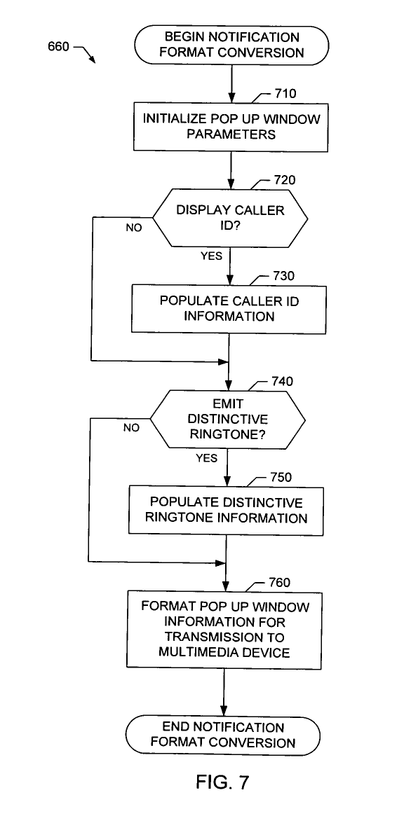

Furthermore, at block 660 the external notification device 115 may reformat the incoming call notification to cause a pop-up window to be displayed by the one or more multimedia devices (e.g., such as the STB 130, the TV 135 and/or the PC 140) indicating that an incoming call is being received by the cellular device 105. As such, the incoming call notification may be formatted to include pop-up window parameters, such as, for example, window location, window size, window color, display duration, default text message to display, etc. Furthermore, at block 660 the incoming call notification may be reformatted to include any caller ID information received from the cellular device 105 and included in the incoming call notification received by the external notification device 115 at block 630. The caller ID information may then be displayed by the one or more multimedia devices in the corresponding pop-up windows. Additionally or alternatively, at block 660 the incoming call notification may be reformatted to include distinctive ring tone information to cause the one or more multimedia devices to emit an audible signal personalized to the cellular device 105 associated with the incoming call and/or the caller ID information associated with the incoming call. Example machine readable instructions that may be used to implement block 660 are shown in FIG. 7 and described in greater detail below.

After processing at block 660 completes, control proceeds to block 670 at which the external notification device 115 routes the reformatted incoming call notification to one or more multimedia devices (e.g., such as the STB 130, the TV 135 and/or the PC 140). For example, at block 660 the external notification device 115 may route the incoming call notification over the digital interface 150 to the STB 130 and/or TV 135. Additionally or alternatively, at block 660 the external notification device 115 may route the incoming call notification over the home network 145 to the PC 140. Control then proceeds to block 670 at which the external notification device 115 may emit an audible signal (e.g., such as a distinctive ring tone) via the external speaker 155 corresponding to receipt of the incoming call notification from the cellular device 105. The external notification device 115 may be configured to emit the audible signal in addition to, or as an alternative to, routing the incoming call notification to one or more of the multimedia devices 130, 135 and/or 140.

Next, control proceeds to block 690 at which the one or more multimedia devices (e.g., such as the STB 130, the TV 135 and/or the PC 140) receive the reformatted incoming call notification from the external notification device 115 and present the incoming call notification in a visual and/or audible format. For example, at block 690 the STB 130 may use the pop-up window information included in the received incoming call notification to cause the TV 135 to present a pop-up window containing caller ID information to notify a user in the vicinity of the TV 135 that an incoming call is being received by the cellular device 105. At block 690 the STB 130 may also cause the TV 135 to emit an audible signal (e.g., a distinctive ring tone) to notify the user that the incoming call is being received by the cellular device 105. Additionally or alternatively, at block 690 the PC 140 may use the browser pop-up window information included in the received incoming call notification to present a browser pop-up window containing caller ID information on the display of the PC 140. At block 690 the PC 140 may also emit an audible signal (e.g., a distinctive ring tone) to notify the user that the incoming call is being received by the cellular device 105. Execution of the example machine readable instructions 600 then ends.

Example machine readable instructions 660 that may be used to perform the processing at block 660 of FIG. 6 are illustrated in FIG. 7. Referring also to FIG. 1, the example machine readable instructions 660 reformat an incoming call notification received by the external notification device 115 into a format suitable for causing incoming call notification information to be presented by a multimedia device (e.g., such as the STB 130, the TV 135 and/or the PC 140). Execution of the example machine readable instructions 660 begins at block 710 at which the external notification device 115 initializes pop-up window parameters to be included in the reformatted incoming call notification and corresponding to a pop-up window to be displayed by a multimedia device (e.g., such as the STB 130, the TV 135 and/or the PC 140) coupled to the external notification device 115. For example, the parameters initialized at block 710 may include a pop-up window location, a pop-up window size, a pop-up window color, a pop-up window display duration, a default text message to display, whether caller ID information should be displayed in the pop-up window, whether a distinctive ring tone should be emitted by the multimedia device, etc. As discussed above, these parameters may be initialized by a configuration operation performed by the external notification device 115 in which the external notification device 115 causes a configuration GUI to be displayed by the multimedia device and corresponding user configuration commands are then returned by the multimedia device to the external notification device 115.

After parameter initialization completes, control proceeds to block 720 at which the external notification device 115 determines whether caller ID information is to be displayed in the pop-up window. If caller ID information is to be displayed (block 720), control proceeds to block 730 at which the external notification device 115 populates the caller ID information received in the original incoming call notification into a field in the reformatted incoming call notification. Control then proceeds to block 740 at which the external notification device 115 determines whether a distinctive ring tone is to be emitted by the multimedia device to indicate that an incoming call is being received by the cellular device 105. If a distinctive ring tone is to be emitted (block 740), control proceeds to block 750 at which the external notification device 115 populates a distinctive ring tone field in the reformatted incoming call notification with appropriate ring tone information (e.g., such as melody selection, loudness, duration, repetition, etc.).

Next, control proceeds to block 760 at which the external notification device 115 formats the pop-up window information for transmission to the one or more multimedia devices. For example, if the multimedia device corresponds to the STB 130 and/or TV 135, at block 760 the external notification device may format the pop-up window information into a form suitable for serial data transmission over the digital interface 150. Additionally or alternatively, if the multimedia device corresponds to the PC 140, at block 760 the external notification device 115 may format the pop-up window information into a form suitable for packet data transmission over the home network 145. In any case, after processing at block 760 completes, execution of the example machine readable instructions 660 then ends.

FIG. 8 is a block diagram of an example computer 800 capable of implementing the apparatus and methods disclosed herein. The computer 800 can be, for example, a server, a personal computer, a personal digital assistant (PDA), an Internet appliance, a DVD player, a CD player, a digital video recorder, a personal video recorder, a set top box, or any other type of computing device. The example computer 800 may implement, for example, any or all of the external notification devices 115, 300 and/or 400 of FIGS. 1, 3 and 4, respectively. The example computer 800 may also implement any or all of the multimedia devices 130, 135 and/or 140 of FIG. 1.

The system 800 of the instant example includes a processor 812 such as a general purpose programmable processor. The processor 812 includes a local memory 814, and executes coded instructions 816 present in the local memory 814 and/or in another memory device. The processor 812 may execute, among other things, the machine readable instructions represented in FIGS. 5-7. Additionally or alternatively, the processor 812 may implement the CPU subsystem 460 of FIG. 4. The processor 812 may be any type of processing unit, such as one or more microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 812 is in communication with a main memory including a volatile memory 818 and a non-volatile memory 820 via a bus 822. The volatile memory 818 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 820 may be implemented by flash memory and/or any other desired type of memory device. Access to the main memory 818, 820 is typically controlled by a memory controller (not shown) in a conventional manner.

The computer 800 also includes a conventional interface circuit 824. The interface circuit 824 may be implemented by any type of well known interface standard, such as an Ethernet interface, a universal serial bus (USB), and/or a third generation input/output (3GIO) interface.

One or more input devices 826 are connected to the interface circuit 824. The input device(s) 826 permit a user to enter data and commands into the processor 812. The input device(s) can be implemented by, for example, a keyboard, a mouse, a touchscreen, a track-pad, a trackball, an isopoint and/or a voice recognition system.

One or more output devices 828 are also connected to the interface circuit 824. The output devices 828 can be implemented, for example, by display devices (e.g., a liquid crystal display, a cathode ray tube display (CRT)), by a printer and/or by speakers. The interface circuit 824, thus, typically includes a graphics driver card.

The interface circuit 824 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 800 also includes one or more mass storage devices 830 for storing software and data. Examples of such mass storage devices 830 include floppy disk drives, hard drive disks, compact disk drives and digital versatile disk (DVD) drives. The mass storage device 830 may implement the memory subsystem 455 of FIG. 4. Additionally or alternatively, the volatile memory 818 may implement the memory subsystem 455.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Intenet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An external notification apparatus comprising:
a first interface to receive an incoming call notification in a first format from a cellular device;
a second interface to route the incoming call notification in a second format to a multimedia device and receive configuration information from the multimedia device; and
a configuration unit to process the configuration information received from the multimedia device.

2. An external notification apparatus as defined in claim 1 further comprising a notification generator to convert the incoming call notification from the first format to the second format.

3. An external notification apparatus as defined in claim 1 wherein the first interface is configured to communicate with at least one of a wireless local area network (WLAN) or a Bluetooth network.

4. An external notification apparatus as defined in claim 1 wherein the first format supports transmission of at least one of an alert message or caller identification information.

5. An external notification apparatus as defined in claim 1 wherein the second format supports transmission of pop-up window information.

6. An external notification apparatus as defined in claim 5 wherein the pop-up window information comprises at least one of window parameter information or multimedia content information.

7. An external notification apparatus as defined in claim 6 wherein the multimedia content information comprises at least one of caller identification information or distinctive ring tone information.

8. An external notification apparatus as defined in claim 1 wherein the second interface is configured to communicate with at least one of a local area network or a digital interface of the multimedia device.

9. An external notification apparatus as defined in claim 1 wherein the multimedia device comprises at least one of a television, a set-top box or a personal computer.

10. An external notification apparatus as defined in claim 1 wherein the cellular device comprises at least one of a mobile cellular telephone or a personal digital assistant.

11. An external notification apparatus as defined in claim 1 wherein the configuration information corresponds to a graphical user interface presented by the multimedia device.

12. An external notification apparatus as defined in claim 1 further comprising a speaker to emit an audio signal in response to receiving the incoming call notification.

13. An external notification apparatus as defined in claim 1 wherein the external notification apparatus is included in a system and the system further includes at least one of the cellular device and the multimedia device.

14. An external notification apparatus comprising:
a first interface to establish a wireless connection with a cellular device and receive an incoming call notification from the cellular device;
a pairing evaluator to determine whether the cellular device is paired with the external notification apparatus; and
a second interface to route the incoming call notification to a multimedia device when at least one of the external notification apparatus is configured to operate in a roaming mode or the external notification apparatus is configured to operate in a secure mode and the pairing evaluator determines that the cellular device is paired with the external notification apparatus.

15. An external notification apparatus as defined in claim 14 further comprising a configuration unit to configure the external notification apparatus to operate in at least one of the secure mode or the roaming mode.

16. An external notification apparatus as defined in claim 14 wherein the first interface is configured to establish the wireless connection by receiving pairing information associated with the cellular device and allowing further communication with the cellular device when the pairing evaluator validates the pairing information.

17. An external notification apparatus as defined in claim 16 wherein the pairing information is based on a passkey.

18. An external notification apparatus as defined in claim 14 wherein the first interface is further configured to initialize pairing between the cellular device and the external notification apparatus by exchanging pairing information between the cellular device and the external notification apparatus.

19. An external notification apparatus as defined in claim 18 wherein the pairing information comprises a passkey.

20. An external notification apparatus as defined in claim 14 wherein the pairing unit is configured to determine whether the cellular device is paired with the external notification apparatus by evaluating pairing information received from the cellular device over the first interface.

21. An external notification apparatus as defined in claim 20 wherein the pairing information is based on a passkey.

22. A method to route an incoming call notification corresponding to a cellular device to a multimedia device for presentation, the method comprising:
receiving the incoming call notification from the cellular device;
converting the incoming call notification from a first format to a second format
routing the incoming call notification to the multimedia device for presentation; and
configuring at least one of the routing or the presentation of the incoming call information based on configuration information provided by the multimedia device.

23. A method as defined in claim 22 wherein the incoming call notification is received over at least one of a wireless local area network (WLAN) or a Bluetooth network.

24. A method as defined in claim 22 wherein the first format supports transmission of at least one of an alert message or caller identification information.

25. A method as defined in claim 22 wherein the second format supports transmission of pop-up window information.

26. A method as defined in claim 25 wherein the pop-up window information comprises at least one of caller identification information or distinctive ring tone information.

27. A method as defined in claim 22 wherein the incoming call notification is routed over at least one of a local area network or a digital interface of the multimedia device.

28. A method as defined in claim 22 wherein the multimedia device comprises at least one of a television, a set-top box or a personal computer.

29. A method as defined in claim 22 wherein the cellular device comprises at least one of a mobile cellular telephone or a personal digital assistant (PDA).

30. A method as defined in claim 22 wherein the configuration information corresponds to a graphical user interface presented by the multimedia device.

31. A method as defined in claim 22 further comprising validating pairing information associated with the cellular device before routing the incoming call notification.

32. A method as defined in claim 31 wherein the pairing information is based on a passkey.

33. An article of manufacture storing machine readable instructions which, when executed, cause a machine to:
receive an incoming call notification from a cellular device;
convert the incoming call notification from a first format to a second format
route the incoming call notification to a multimedia device for presentation; and
configure at least one of the routing or the presentation of the incoming call information based on configuration information provided by the multimedia device.

34. An article of manufacture as defined in claim 33 wherein the first format supports transmission of at least one of an alert message or caller identification information.

35. An article of manufacture as defined in claim 33 wherein the second format supports transmission of pop-up window information.

36. An article of manufacture as defined in claim 35 wherein the pop-up window information comprises at least one of caller identification information or distinctive ring tone information.

37. An article of manufacture as defined in claim 33 wherein the configuration information corresponds to a graphical user interface presented by the multimedia device.

38. An article of manufacture as defined in claim 33 wherein the machine readable instructions, when executed, further cause the machine to validate pairing information associated with the cellular device before routing the incoming call notification.

39. An article of manufacture as defined in claim 38 wherein the pairing information is based on a passkey.
